(19) United States
(12) Patent Application Publication
(10) Pub. No.: US 2015/0312660 A1
(43) Pub. Date: Oct. 29, 2015

(54) ACOUSTIC MEMBRANE WITH ASYMMETRIC LAYER ARRANGEMENT

(71) Applicant: Knowles IPC (M) Sdn. Bhd., Penang (MY)

(72) Inventors: Christian Lembacher, Gramatneusiedl (AT); Armin Timmerer, Vienna (AT)

(21) Appl. No.: 14/699,548

(22) Filed: Apr. 29, 2015

Related U.S. Application Data
(60) Provisional application No. 61/985,837, filed on Apr. 29, 2014.

(51) Int. Cl. H04R 1/00; H04R 31/00

(52) U.S. Cl. CPC H04R 1/00; H04R 31/00; H04R 2231/001

(57) ABSTRACT

A membrane for an acoustic transducer may comprise a first layer comprising a first material, a second layer disposed on the first layer, the second layer comprising a second material that is different from the first material, and a third layer disposed on the second layer, the third layer comprising a third material that is different from the first material and the second material, the third layer configured to be coupled with a moveable coil. The first material may be a polyaryletherketone (PAEK), the second material may be acrylate, and the third material may be polyetherimide (PEI), polycarbonate (PC), or another similar material.

### CROSS-REFERENCE TO RELATED APPLICATION

This application claims the benefit of priority to U.S. provisional application No. 61/985,837, filed Apr. 29, 2014, which is hereby incorporated by reference in its entirety.

### BACKGROUND

a. Technical Field

The present invention generally relates to acoustic transducers, including membranes for acoustic transducers.

b. Background Art

Acoustic membranes (i.e., membranes for electro-acoustic transducers, including speakers and microphones) may be designed and manufactured to optimize numerous characteristics. First, membranes should meet chosen acoustic criteria to ensure acceptable sound reproduction over a desired frequency range. Second, membranes should function well over a range of temperatures, as the membrane and its environment may rise in temperature as a result of transducer operation. Third, membranes should have acceptable fatigue behavior (e.g., acceptable level of reduction in the sound reproduction capabilities of the membrane over time) to enable a long lifetime of the transducer.

Acoustic membranes with more than one layer have been used in the past. Such membranes generally have a symmetric layer arrangement to enable equal movement and stiffness of the membrane in both directions of excursion of the membrane. For example, one known arrangement using a five-layer arrangement, where the outside layers are made from the same thermoplastic material, and an inner most layer serves as a carrier layer, with layers of an adhesive between the inner carrier layer and the outer layers. With five different layers, the costs and production time of such membranes can be high. Another example of a known arrangement includes a central layer of acrylate material as an adhesive with layers of the same thermoplastic material on both sides of the central layer. To ensure good acoustic performance, a high quality thermoplastic material is used for the outside layers. There is a need, however, for a multi-layer compound acoustic membrane that achieves similar or better acoustic performance as existing examples at a lower cost.

### BRIEF SUMMARY

The present disclosure provides, among other things, a multi-layer membrane for an acoustic transducer that may provide improved sound reproduction, thermal stability, and a long life time at a reduced cost relative to known multi-layer membrane configurations. In an embodiment, such a membrane may comprise a first layer comprising a first material, a second layer disposed on the first layer, the second layer comprising a second material that is different from the first material, and a third layer disposed on the second layer, the third layer comprising a third material that is different from the first material and the second material. The third layer may be configured to be coupled with a moveable coil. The first material may be a polyaryletherketone (PAEK), such as polyether ether ketone (PEEK), the second material may be acrylate, and the third material may be polyetherimide (PEI) or polycarbonate (PC).

An embodiment of a method of manufacturing an acoustic transducer may comprise providing a first membrane layer, the first membrane layer comprising a first thermoplastic material, disposing a second membrane layer on the first membrane layer, and disposing a third membrane layer on the second membrane layer, the third membrane layer comprising a second thermoplastic material that is different from the first thermoplastic material, the second thermoplastic material being more chemically reactive than the first thermoplastic material.

An embodiment of an acoustic transducer may comprise a moveable electromagnetic coil and a membrane. The membrane may comprise a first layer comprising a first material, a second layer disposed on the first layer, the second layer comprising a second material that is different from the first material, and a third layer disposed on the second layer, the third layer comprising a third material that is different from the first material and the second material. The third layer may be coupled with the coil. The third material may be PEI or PC.

### BRIEF DESCRIPTION OF THE DRAWINGS

FIG. 1 is a cross-sectional view of an exemplary embodiment of an electro- acoustic transducer.

FIG. 2 is a diagrammatic view of an exemplary embodiment of a multi-layer membrane of an acoustic transducer.

FIG. 3 is a diagrammatic view of an exemplary embodiment of a multi-layer membrane of an acoustic transducer.

FIG. 4 is a flow chart illustrating an exemplary embodiment of a method of manufacturing an acoustic transducer.

FIG. 5 is a plot illustrating exemplary values of temperature and pressure over time for a stamping process that may be used in the method of FIG. 4.

FIG. 6 is a plot illustrating exemplary values of temperature and pressure over time for a deep drawing process that may be used in the method of FIG. 4.

FIGS. 7 to 9 are plots illustrating the acoustic performance of a transducer including an exemplary asymmetric multi-layer membrane and the acoustic performance of a transducer including an exemplary symmetric multi-layer membrane.

### DETAILED DESCRIPTION

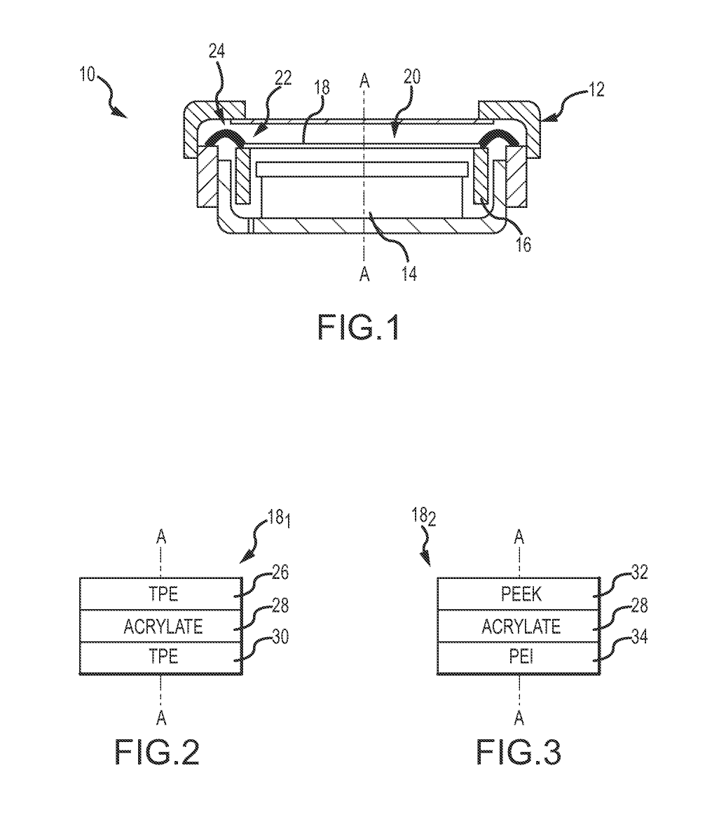

Referring to the drawings, wherein like reference numerals refer to the same or similar features in the various views, FIG. 1 is a cross-sectional view of an embodiment of an acoustic transducer 10. The transducer may include a housing 12, a stationary magnet 14, an electromagnetic coil 16, and a membrane 18. The membrane 18 may be coupled to the coil 16 and/or to the housing 12, in an embodiment, and the membrane 18 and coil 16 may be moveable relative to the stationary magnet 14. In an embodiment in which the transducer 10 is used in a speaker, an AC signal may be fed into the coil 16, which signal may cause the coil 16 to produce a magnetic field, which field may interact with a magnetic field produced by the stationary magnet 14 so as to move the coil 16 and membrane 18 relative to the stationary magnet 14, whereby the membrane 18 may produce an acoustic pressure wave.

The transducer 10 may find use, for example only, as a part of a microphone and/or speaker, in an embodiment, in any appropriate application. For example, the transducer 10 may find use in a cell phone or other portable device, in an embodiment.

The membrane 18 may have a circular, rectangular, or other shape, depending on the desired shape and properties of the transducer 10. The membrane 18 and coil 16 may be generally disposed around an axis A, and the membrane 18 may generally include three radial portions, in an embodiment. The membrane may include a central radial portion 20, a transition radial portion 22, and an outer radial portion 24. The transition portion 22 may be coupled with the moveable electromagnetic coil 16, in an embodiment, and the outer portion 24 may include a dome structure and may be coupled with a portion of the housing 12.

Ideally, the pressure wave produced by the membrane 18 would perfectly reproduce the signal characteristics of the signal input to the coil 16 across a wide range of frequencies, over a wide range of temperatures, and over a long life time of the transducer. Furthermore, particularly in micro-transducer embodiments (e.g., cell phone speakers and microphones), it may be desirable to reduce the excursion of the membrane 18 to allow for the size of the transducer 10 to be decreased. As a result, goals for the membrane 18 may include accurate sound reproduction, a large temperature tolerance, and a long life time, with minimal membrane excursion. In an embodiment, a multi-layer membrane may be used in the transducer 10, with different layers of the membrane providing different ones of the above-noted desired characteristics.

FIG. 2 is a diagrammatic view of a first embodiment of the membrane 18₁, in which the membrane 18₁ comprises three layers 26, 28, 30 arranged along the axis A. The central layer 28 may comprise acrylate and/or another material exhibiting good damping properties (e.g., to reduce membrane excursion) at a desired resonance frequency and/or frequency range of the membrane 18₁. The outer layers 26, 30 may comprise respective thermoplastic elastomer (TPE) materials, in an embodiment, selected to improve the fatigue behavior (i.e., less reduction in the sound reproduction capabilities of the membrane over time) of the membrane 18₁ relative to a membrane consisting only of acrylate or another relatively soft material. The TPE layers 26, 30 may include, for example only and without limitation, one or more of a polymer from the polyaryletherketone (PAEK) family, such as polyether ether ketone (PEEK), PEK, PEEKK, or PEKEKK. The TPE layers 26, 30 may additionally or alternatively include polyethylene terephthalate (PET), polyethylene naphthalate (PEN), polyetherimide (PEI), polycarbonate (PC), polyarylate (PAR), and/or another polymer. The membrane layers 26, 28, 30 may be asymmetric, in an embodiment (i.e., with a first TPE layer 26 consisting of a different material composition than the second TPE layer 30). The layers may have the same radial dimensions as each other, in an embodiment (i.e., may have the same cross-sections taken transverse to the axis A). Each of membrane layers 26, 28, 30 may consist of a single respective material, in an embodiment (e.g., a single one of the materials named herein). Alternatively, a single membrane layer 26, 28, 30 may include numerous materials, in an embodiment.

FIG. 3 is a diagrammatic view of an embodiment of a membrane 18₂ for an acoustic transducer having an asymmetric layer arrangement. The membrane 18₂ may include three layers 32, 28, 34 arranged along the axis A: a first layer 32 having a first material composition, a second layer 28 disposed on the first layer 32 and having a second material composition, and a third layer 34 disposed on the second layer 28 and having a third material composition. In an embodiment, the first, second, and third material compositions may be different from each other. In an embodiment, the first layer 32 may be or may include a PAEK material, the second layer 28 may be or may include acrylate material, and the third layer 34 may be or may include PEI, PC, PAR, PEN, and/or PET material.

As noted above, a middle layer 28 consisting of acrylate may be used due to the excellent damping properties of acrylate in the typical frequency range of acoustic transducers (e.g., sounds in the human-audible frequency range). The damping properties of acrylate may reduce the excursion of the membrane 18₂, thereby permitting the transducer assembly to be reduced in size relative to a membrane having a larger excursion. The acrylate may be or may include, for example, an acrylate adhesive. Instead of or in addition to acrylate, a silicon adhesive may be used.

PEEK (or another PAEK material) may be used for one or more outer layers (e.g., the first layer 32) because of its good fatigue behavior. PEEK may have a crystalline structure (i.e., may be arranged in an ordered pattern at the atomic or molecular level—such atomic or molecular level structure may be referred to herein as crystallinity), may have a glass transition temperature of about one hundred and forty-one degrees Celsius (141° C.), and may be an anisotropic material. In an embodiment, instead of or in addition to PEEK, a material having some or all of the same material properties as PEEK (such as, for example, another PAEK material) may be used in the first layer 32 of the membrane 18₂.

PEI may be used for one or more outer layers (e.g., the third layer 34) because of its excellent gluing behavior and relatively low cost. That is, a membrane 18₂ consisting of layers 32, 28, 34 of PEEK, acrylate, and PEI may be lower in cost and easier to couple with a coil in a transducer than a membrane consisting of layers of PEEK, acrylate, and PEEK. PEI may have an amorphous crystallinity (i.e., an irregular order at the atomic or molecular level), may have a glass transition temperature of about two hundred and seventeen degrees Celsius (217° C.), and may be an isotropic material. PEI may provide improved gluing behavior (e.g., relative to a PAEK material) because PEI may be more chemically reactive than PAEK materials, in embodiments. In an embodiment, instead of or in addition to PEI, a material having some or all of the material properties as PEI (such as, for example, PC, PAR, PET or PEN) may be used in the third layer of the membrane.

FIG. 3 illustrates a specific embodiment of a three-layer asymmetric membrane including layers of PEEK, acrylate adhesive, and PEI. Other specific embodiments consistent with the present disclosure include membranes comprising: PAR, acrylate adhesive, and another TPE; and PAR, acrylate adhesive, and PEEK.

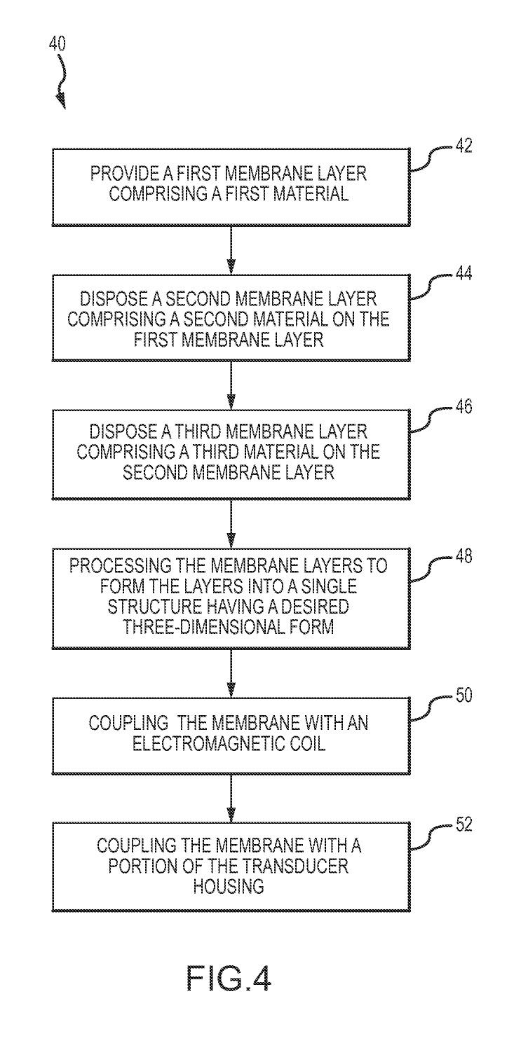

FIG. 4 is a flow chart illustrating a method 40 of manufacturing an acoustic transducer, such as the transducer illustrated in FIG. 1, with a multi-layer membrane, such as the membrane of FIG. 3. Referring to FIG. 4, the method 40 may begin with a step 42 that includes providing a first membrane layer comprising a first material. In an embodiment, the first membrane layer may comprise a thermoplastic material. In an embodiment, the first thermoplastic material may be or may include PEEK, or may be or may include a TPE having at least some of the same material properties as PEEK (such as, for example, another PAEK material).

The method 40 may further include a step 44 that includes disposing a second membrane layer comprising a second material that is different from the first material on the first membrane layer. The second membrane layer may comprise an acrylate material, in an embodiment.

The method 40 may further include a step 46 that includes disposing a third membrane layer comprising a third material that is different from the first and second materials on the second membrane layer. The third membrane layer may comprise a thermoplastic material that is different from the thermoplastic material used for the first membrane layer. For example, the third membrane layer may be or may include a PEI material or a TPE material having at least some of the same material properties as PEI (such as, for example, PC, PAR, PET or PEN).

The method 40 may further include a step 48 that includes processing the membrane layers to form the layers into a single membrane structure having a desired three-dimensional form. In an embodiment, the three-dimensional form of the membrane may include a central portion, transition portion, and outer portion as illustrated for the membrane 18 in FIG. 1. In an embodiment, the processing step may include one or more thermoforming processes.

A first thermoforming process that may be used in the processing step is a stamping process. In an embodiment, a stamping process may include the use of a closed air cylinder to apply air pressure to form the membrane. FIG. 5 is a plot illustrating exemplary values of temperature (TEM) and pressure (P) over time that may be used in a stamping process. The stamping process may include a first stage 60 in which the temperature may begin at seventy degrees Celsius (70° C.) and may be gradually increased to about one hundred and thirty-five degrees Celsius (135° C.) over a period of about forty (40) seconds with atmospheric pressure. In a second stage 62, the temperature may be gradually increased from about one hundred and thirty-five degrees Celsius (135° C.) to about two hundred degrees Celsius (200° C.) over a period of about seventy (70) seconds with pressure at about 2.1 bar. In a third stage 64, temperature may be maintained at about two hundred degrees Celsius (200° C.) and pressure may be maintained at about 2.1 bar for about fifty (50) seconds. Finally, in a fourth stage 66, temperature may be gradually reduced from about two hundred degrees Celsius (200° C.) to about fifty degrees Celsius (50° C.) over a period of about sixty (60) seconds with pressure at about 2.1 bar.

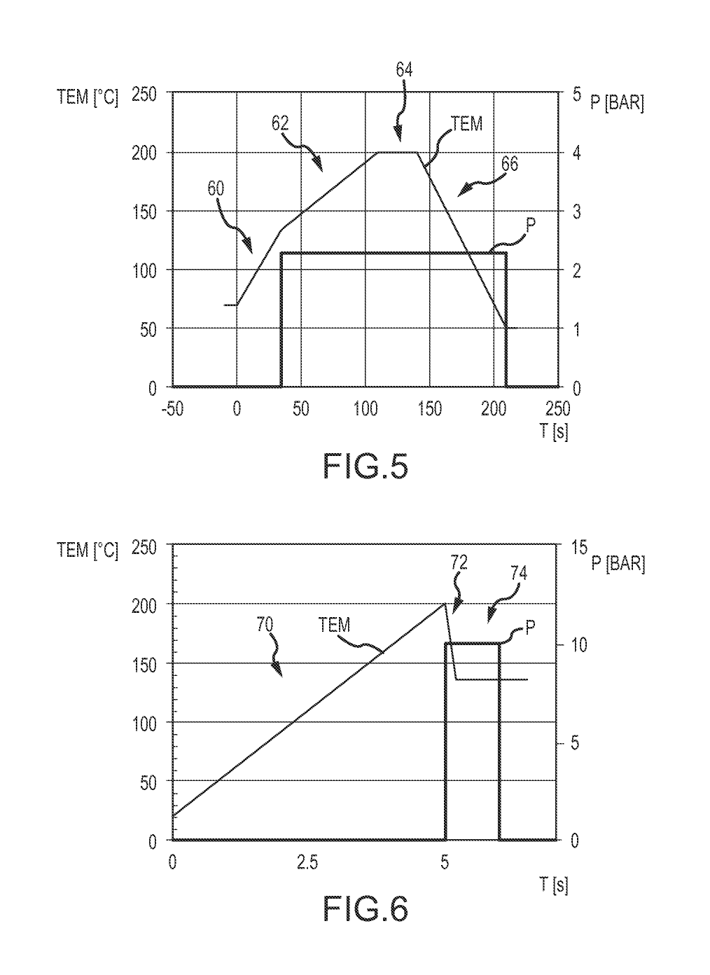

A second thermoforming process that may be used in the processing step is a drawing process. In an embodiment, a drawing process may include the application of air pressure to form the membrane. FIG. 6 is a plot illustrating exemplary values of temperature (TEM) and pressure (P) over time that may be used in a drawing process. The drawing process may include a first stage 70 in which the temperature may start at about twenty degrees Celsius (20° C.) and is gradually raised to about two hundred degrees Celsius (200° C.) over a period of about five (5) seconds with atmospheric pressure. A second stage 72 may include rapidly reducing the temperature from about two hundred degrees Celsius (200° C.) to about one hundred and thirty degrees Celsius (130° C.) in less than a second with pressure at about ten (10) bar. A third stage 74 may include maintaining temperature at about one hundred and thirty degrees Celsius (130° C.) and pressure at about ten (10) bar for about one (1) second.

Referring again to FIG. 4, the method 40 may further include a step 50 that includes coupling the membrane with an electromagnetic coil. Coupling the membrane with the coil may include coupling the membrane with the coil with an adhesive (i.e., gluing the membrane to the coil), in an embodiment. In an embodiment, the third layer of the membrane (which may comprise, e.g., PEI, PC, PAR, PET or PEN) may be coupled with the coil.

The method 40 may further include a step 52 that includes coupling the membrane with a portion of the housing of the transducer. Coupling the membrane with the housing may include coupling the membrane with the housing with an adhesive (i.e., gluing the membrane to the housing), in an embodiment. In an embodiment, the third layer of the membrane (which may comprise, e.g., PEI, PC, PAR, PET or PEN) may be coupled with the housing.

It should be noted that numerous additions and alterations may be made to the method as explicitly illustrated and described without departing from the scope and spirit of the instant disclosure. For example, although certain steps of the method have been illustrated and described in a particular order, that order is not limiting except as explicitly set forth in the claims or as required by logic. Furthermore, additional steps may be performed in the method to complete the manufacture of a transducer, such as forming the membrane layers individually, forming the housing of the transducer, etc., which steps are within the ability and knowledge of a person of skill in the art.

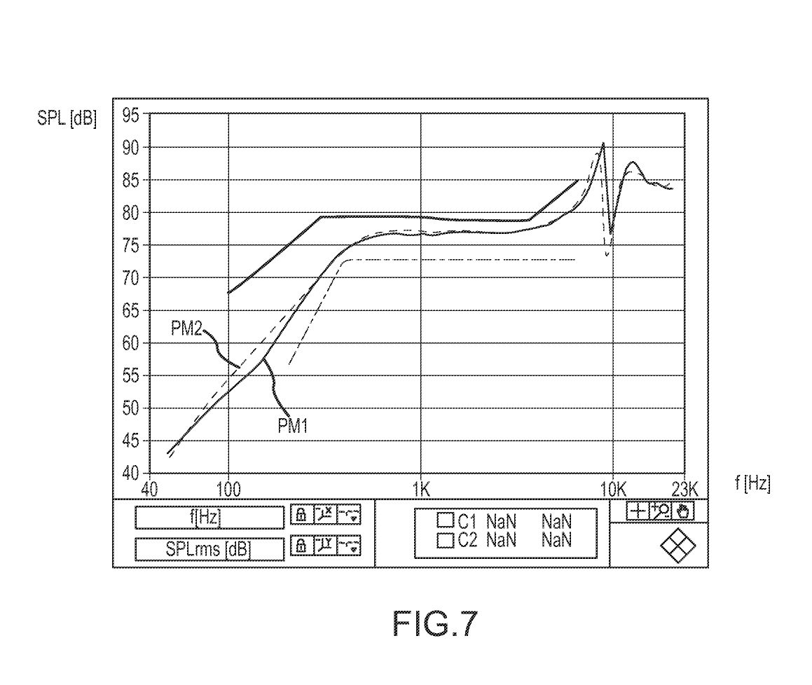

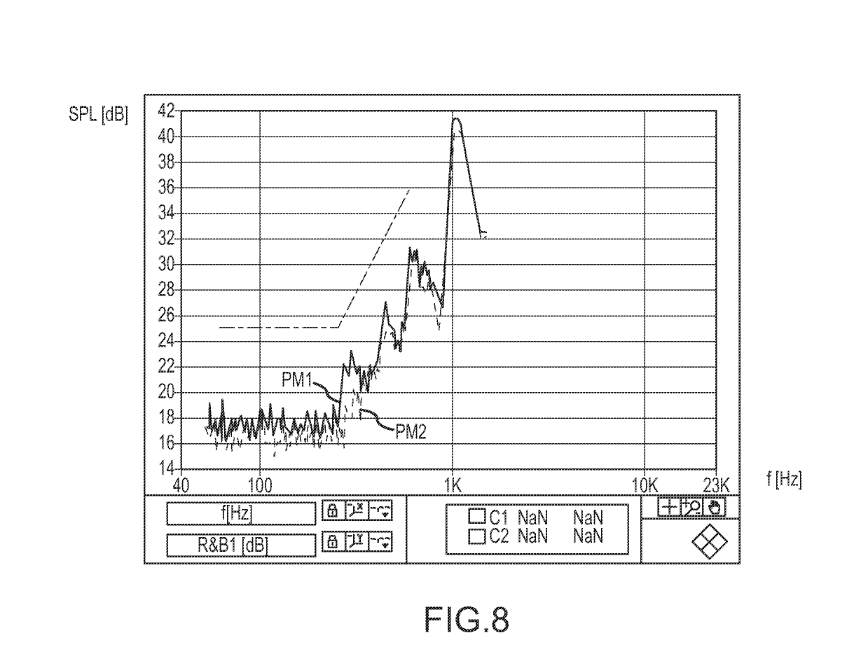

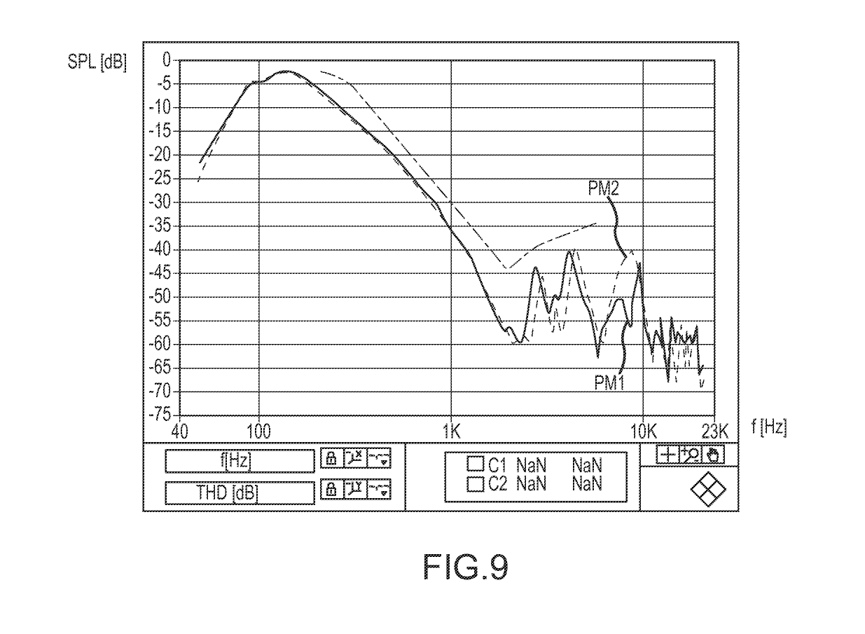

FIGS. 7 to 9 are plots illustrating the respective responses, to various input signals, of an exemplary asymmetric membrane having layers comprising PEEK, acrylate, and PEI (e.g., as illustrated and described with respect to FIG. 3) and a symmetric membrane having layers comprising PEEK, acrylate, and PEEK. The responses are shown in decibels (dB) of sound level pressure (SPL) across a range of frequencies (f) in Hertz (Hz). As shown in the plots, the response PM1 of the asymmetric membrane is similar to the response PM2 of the symmetric membrane for most input signals. Advantageously, an asymmetric membrane having a PEEK-acrylate-PEI layer structure may offer better thermal and fatigue behaviors than a symmetrical PEEK-acrylate-PEEK membrane, and may be lower in cost, without sacrificing sound reproduction quality.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A membrane for an acoustic transducer, the membrane comprising:
a first layer, the first layer comprising a first material;
a second layer, disposed on the first layer, the second layer comprising a second material that is different from the first material; and
a third layer configured to be coupled with a moveable coil, the third layer disposed on the second layer, the third layer comprising a third material that is different from the first material and the second material;
wherein the first material comprises a polyaryletherketone, the second material comprises adhesive, and the third material is selected from the list consisting of polyetherimide, polyethylene terephthalate, polyethylene naphthalate, polycarbonate, and polyarylate.

2. The membrane of claim 1, wherein the first material comprises polyetheretherketone.

3. The membrane of claim 1, wherein the third material comprises polyetherimide.

4. The membrane of claim 1, wherein the third material has a higher glass transition temperature than the first material.

5. The membrane of claim 1, wherein respective radial cross-sections of the first layer, the second layer, and the third layer have substantially the same dimensions.

6. The membrane of claim 1, wherein the second material comprises acrylate adhesive or silicon adhesive.

7. The membrane of claim 1, wherein the first layer, the second layer, and the third layer are the only layers of the membrane.

8. A method of manufacturing an acoustic transducer, the method comprising:
providing a first membrane layer, the first membrane layer comprising a polyaryletherketone material;
disposing a second membrane layer on the first membrane layer, the second membrane layer comprising adhesive; and
disposing a third membrane layer on the second membrane layer, the third membrane layer comprising a second thermoplastic material that is different from the first thermoplastic material, the second thermoplastic material comprising at least one of polyetherimide, polyethylene terephthalate, polyethylene naphthalate, polycarbonate, and polyarylate.

9. The method of claim 8, further comprising coupling the third membrane layer with a coil.

10. The method of claim 9, wherein coupling the third membrane layer with a coil comprises gluing the third membrane layer to the coil.

11. The method of claim 8, further comprising thermoforming the first layer, the second layer, and the third layer into a membrane.

12. The method of claim 11, wherein the thermoforming comprises stamping.

13. The method of claim 11, wherein the thermoforming comprises drawing.

14. The method of claim 8, wherein the second thermoplastic material is polyetherimide.

15. The method of claim 14, wherein the first thermoplastic material is a polyaryletherketone.

16. An acoustic transducer, comprising:
a moveable electromagnetic coil; and
a membrane, the membrane comprising:
a first layer comprising a first material;
a second layer, disposed on the first layer, the second layer comprising a second material that is different from the first material; and
a third layer, disposed on the second layer and coupled with the coil, the third layer comprising a third material that is different from the first material and the second material;
wherein the first material comprises a polyaryletherketone, the second material comprises adhesive, and the third material is selected from the list consisting of polyetherimide, polyethylene terephthalate, polyethylene naphthalate, polycarbonate, and polyarylate.

17. The transducer of claim 16, wherein the second material comprises acrylate adhesive or silicon adhesive.

18. The transducer of claim 16, wherein the first layer comprises polyetheretherketone.

19. The transducer of claim 16, wherein the first layer, the second layer, and the third layer are the only layers of the membrane.

20. The transducer of claim 16, wherein respective radial cross-sections of the first layer, the second layer, and the third layer have substantially the same dimensions.
